(19) United States
(12) Patent Application Publication
(10) Pub. No.: US 2003/0085655 A1
(43) Pub. Date: May 8, 2003

(54) Low-pressure mercury discharge lamp

(76) Inventors: Adrianus Johannes Hendricus Petrus Van Der Pol, Eindhoven (NL); Augustinus Johannes Henricus Van Der Heijden, Eindhoven (NL); Michiel Jacobus Van Der Meer, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/262,364

(22) Filed: Oct. 1, 2002

(30) Foreign Application Priority Data
Oct. 4, 2001 (EP) 01203769.3

(51) Int. Cl. H01J 17/20

(52) U.S. Cl. 313/568; 313/576; 313/641

(57) ABSTRACT

Low-pressure mercury discharge lamp (1) comprising an at least partly substantially cylindrical discharge vessel (3) having a diameter D, wherein two electrodes are present near respective ends of said discharge vessel (3), which discharge vessel (3) is filled with a mixture of inert gasses having a pressure P and which discharge vessel (3) contains an amount of mercury, wherein D×P is at least 5.2 mPa. The invention is based on the novel understanding that a higher filling pressure of the inert gas mixture causes a lower mercury consumption in the lamp (1).

The invention relates to a low-pressure mercury discharge lamp comprising an at least partly substantially cylindrical discharge vessel in which two electrodes are arranged at respective ends and which is filled with a rare gas mixture, furthermore comprising a quantity of mercury.

Such a lamp is generally known and is also referred to as a TL lamp, the discharge vessel comprising an elongate straight glass tube. Compact lamps (“energy savers”), in which the discharge vessel is formed by a multiply curved thin glass tube or by several short tubes in communication with one another also belong to this category of lamps.

An electrical discharge is maintained between the two electrodes of the lamp during operation. The electrodes, which collide with the evaporated mercury atoms at high velocity, bring electrons of the mercury atoms into a higher energetic orbit. When the electrons drop back to the original levels, the mercury atom emits ultraviolet radiation. A fluorescent layer is provided against the inner side of the glass discharge vessel, for example a phosphor which converts the ultraviolet radiation into visible light.

A problem which arises in such lamps is that mercury atoms are absorbed by the discharge vessel, in particular by the fluorescent layer and the glass discharge vessel. This becomes visible from the outside as black stains in the course of time. The decrease in the number of free mercury atoms adversely affects lamp operation in the course of time, which is why an extra quantity of mercury is usually added so as to be able to build up a sufficiently high, i.e. a saturated or substantially saturated mercury vapor pressure at least until the end of lamp life. It is known, however, that mercury is an environmentally hazardous substance whose use should be limited.

The invention accordingly has for its object to provide an inexpensive and/or reliable low-pressure mercury vapor discharge lamp which has a low mercury consumption and/or whose properties are less dependent on age or temperature.

According to the invention, the lamp is for this purpose characterized in that the product of the diameter D of the cylindrical discharge vessel and the filling pressure P of the rare gas mixture is at least 5.2 mPa (meter×Pascal). The invention is based on the novel recognition that a higher filling pressure of the rare gas mixture leads to a reduced mercury consumption in the lamp.

The filling pressure of the conventional low-pressure mercury discharge lamp is usually made to depend on the lamp diameter, for which it is true that the greater the diameter of the lamp, the lower the filling pressure which is chosen. A rule of thumb usually applied is that the product of pressure and diameter must not be greater than a certain constant, for example 5.0 mPa. This leads to a maximum filling pressure of 500 Pa for a lamp having a diameter of 10 mm, to a maximum filling pressure of 310 Pa for a diameter of 15.8 mm (5/8inch), and to a maximum filling pressure of 200 Pa for a diameter of 25.4 mm (8/8 inch). It has been assumed until now that a higher filling pressure has a significant negative effect on the luminous efficacy of the lamp. According to the recognition on which the invention is based, however, a higher filling pressure has a positive influence on the mercury consumption of the lamp, and thus on lamp life and lamp properties, while at the same time the environment is spared and the adverse effects on the lumen output are of minor importance.

An explanation for the lower mercury consumption of the lamp at a higher filling pressure may be that the mercury ions, which move with high velocity through the discharge vessel, are decelerated by the additional rare gas atoms, so that said ions collide with the discharge vessel wall at a lower velocity and are less readily absorbed therein. As a result, there will be less blackening of the lamp, and less mercury need be introduced into the lamp during manufacture for maintaining a saturated mercury vapor pressure throughout lamp life. Preferably, therefore, the quantity of mercury is at most approximately equal to 10 times, more preferably 6 times, even more preferably 3 times the quantity of mercury necessary for achieving a saturated mercury vapor pressure during nominal operation of the lamp.

It is even possible in this manner to manufacture a lamp which has a sufficiently long lamp life in combination with a somewhat unsaturated, constant mercury vapor pressure, such that the lamp exhibits a constant, temperature-independent characteristic. In this case, the quantity of mercury introduced into the discharge vessel during manufacture is less than the quantity of mercury required for achieving a saturated mercury vapor pressure during nominal operation of the lamp. Such an unsaturated mercury lamp has the additional advantage that the environment is less strongly burdened.

Preferably, D×P is at least 8.0 mPa, more preferably at least 12.0 mPa. It was found in experiments that the mercury consumption becomes lower in proportion as the filling pressure becomes higher. There is indeed a maximum filling pressure for which, when it is exceeded, the mercury consumption does not decrease substantially any more, while also the adverse effects on the luminous efficacy start to become noticeable. This maximum, however, seems to be dependent on the current strength through the lamp.

The advantages of the invention manifest themselves especially in lamps of somewhat greater diameter, which had very low filling pressures until now, such as a lamp having a diameter D of 15.9 mm (5/8 inch), or the widely used 25.4 mm (8/8 inch). Preferably, the filling pressure P of such a lamp is at least 200 Pa, more preferably at least 520 Pa, even more preferably at least 800 Pa. Following the rule of thumb mentioned above, comparatively high filling pressures do occur already in lamps having a smaller diameter such as those, for example, described in the patent document U.S. Pat. No. 4,546,285, which discloses a compact low-pressure mercury discharge lamp with a diameter of 10 mm and a maximum filling pressure of 520 Pa.

The invention will now be explained in more detail below with reference to an embodiment shown in the Figure and the results of a few experiments.

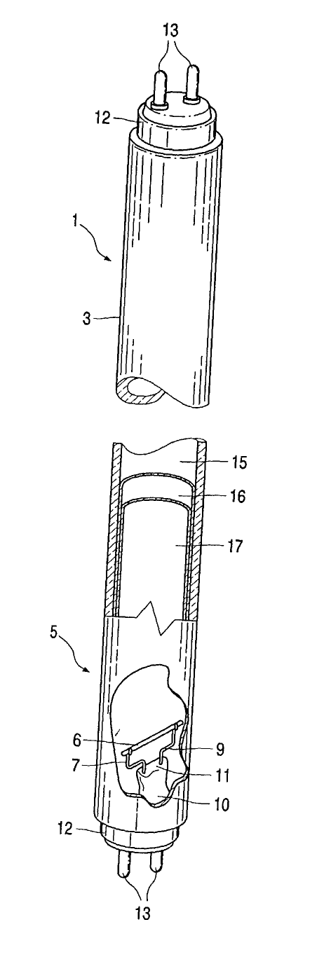

FIG. 1 shows a low-pressure mercury discharge lamp 1 with an elongate glass discharge vessel 3. The lamp comprises an electrode 5 at each end, which electrode is formed by a tungsten incandescent coil 6 supported by conducting lead wires 7, 9 which extend through a glass pinch 11 which is provided on a glass stem 10. The incandescent coil 6 is provided with an emitter material such as oxides of barium, calcium, and strontium for reducing the work function of the electrode. The stem 10 hermetically seals off the discharge vessel 3. The lead wires 7, 9 are connected to pin-type contacts 13 in the respective end caps 12 which are provided at either end of the lamp 1.

A mercury protection layer 16 is provided against the inner surface 15 of the discharge vessel 3, and a halophosphate layer 17 is provided on said layer. The layer 16 is provided for reducing the absorption of mercury by the glass of the discharge vessel and may comprise an oxide of magnesium, aluminum, titanium, or zirconium, or a similar material.

The discharge vessel 3 is filled with a rare gas mixture comprising one or several of the gases xenon, krypton, argon, and neon under a certain filling pressure. The discharge vessel 3 is further provided with a sufficient quantity of mercury.

Tests were carried out with such a lamp 1, in which the lamp 1 was fastened in a suitable luminaire and was supplied by a suitable ballast. Various gas fillings were tested at various pressures. The mercury absorption in the wall of the lamp 1 was determined after each test and the values were compared. The results of these tests are shown below.

Philips TLD lamp:

diameter: 25.4 mm (8/8 inch)

length: 1.20 m

gas mixture composition: 75% krypton/25% argon

power: 36W

An increase in the filling pressure from 2.0 mbar to 3.2 mbar resulted in a reduction in the absorption of mercury atoms of 30 to 35% adjacent the electrodes after 1000 hours of operation, and in a reduction of 40 to 50% adjacent the center of the discharge vessel.

Philips TL5 lamp:

diameter: 15.9 mm (5/8 inch)

length: 1.14 m

gas mixture composition: 20% krypton/80% argon

power: 28W

An increase in the filling pressure from 2.8 mbar to 5 mbar resulted in an average reduction in the absorption of mercury atoms of approximately 29% after 1000 hours of operation. A further increase of the filling pressure to 8 mbar resulted in a reduction of approximately 64%.

Philips TL5 lamp:

diameter: 15.9 mm (5/8 inch)

length: 1.14 m

gas mixture composition: 20% krypton/80% argon

power: 54W

An increase in the filling pressure from 2.8 mbar to 8 mbar resulted in an average reduction in the absorption of mercury atoms of approximately 29% after 1000 hours of operation. A further increase of the filling pressure to 12 mbar resulted in a reduction of approximately 41%. A further increase of the filling pressure to 16 mbar and 20 mbar, respectively, resulted in a reduction of approximately 45% both times, which would seem to indicate that an upper limit for the mercury reduction made possible by an increase in the filling pressure has been reached for this lamp type.

The invention renders it possible to use a considerably smaller quantity of mercury than has been usual until now in the lamp 1. Thus a minimum quantity of approximately 0.02 mg mercury has to be present in said Philips T5 lamp for achieving a saturated mercury vapor pressure during operation. The dose of approximately 4 mg used in practice can be reduced to less than, for example, 0.20 mg, 0.12 mg, or even less than 0.06 mg by means of the invention without any sacrifice as regards lamp life.

1. A low-pressure mercury discharge lamp (1) comprising an at least partly substantially cylindrical discharge vessel (3) with a diameter D in which two electrodes are arranged at respective ends and which is filled with a rare gas mixture at a pressure P, furthermore comprising a quantity of mercury, characterized in that D×P is at least 5.2 mPa.

2. A low-pressure mercury vapor discharge lamp (1) as claimed in claim 1, characterized in that D×P is at least 8.0 mPa, preferably at least 12.0 mPa.

3. A low-pressure mercury vapor discharge lamp (1) as claimed in claim 1 or 2, characterized in that the quantity of mercury is at most approximately equal to 10 times, preferably 6 times, more preferably 3 times the quantity of mercury necessary for obtaining a saturated mercury vapor pressure during nominal operation of the lamp (1).

4. A low-pressure mercury vapor discharge lamp (1) as claimed in claim 1, 2, or 3, characterized in that D is at least 15.9 mm (5/8″).

5. A low-pressure mercury vapor discharge lamp (1) as claimed in any one of the preceding claims, characterized in that P is at least 200 Pa, more preferably at least 520 Pa, even more preferably at least 800 Pa.

6. A low-pressure mercury vapor discharge lamp (1) as claimed in any one of the preceding claims, characterized in that the rare gas mixture mainly consists of one or several of the gases argon, krypton, xenon, and neon.
